(19) United States
(12) Patent Application Publication
(10) Pub. No.: US 2006/0290567 A1
(43) Pub. Date: Dec. 28, 2006

(54) Positioning system

(75) Inventor: Jose Dirceu Grundler Ramos, Porto Alegre (BR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/187,716

(22) Filed: Jul. 22, 2005

(30) Foreign Application Priority Data
Jul. 23, 2004 (GB) 0416478.6

(51) Int. Cl. G01S 3/02

(52) U.S. Cl. 342/463

(57) ABSTRACT

Embodiments of the present invention relate to a positioning system that utilises differences in times of flight information between selected pairs of positioning receivers to calculate the position of a mobile station, the time of flight information are being derived from data packets successively received at the positioning receivers.

### FIELD OF THE INVENTION

The present invention relates to a positioning system and method and, more particularly, to such a system and method for determining the location of a mobile station.

### BACKGROUND TO THE INVENTION

The well-known global positioning system (GPS) is the most widely used positioning system. It is used to provide position information relating to, for example, cars and boats, etc. It uses dedicated GPS hardware and software in conjunction with a number of satellites to provide that position information. It is possible to buy a standalone global positioning system that can be transferred from vehicle to vehicle. It is also possible to buy dedicated hardware to allow such a global positioning system to be used in conjunction with a mobile computing device such as a mobile computer. However, providing such a GPS system to track the location of mobile computing devices has several disadvantages. Firstly, as already mentioned, a specific GPS system suitable for use in mobile computers is required, which increases the cost, size and power consumption of such mobile computers. Secondly, it is well-known that GPS systems do not work satisfactorily indoors. Still further, the resolution of the position information provided by commercial GPS systems is thought to be unsuitable for locating a mobile computing device.

It is also known within the art to use additional signals such as, for example, ultrasound or infrared signals, to locate mobile computers of a wireless LAN. However, again, dedicated hardware is required for the mobile devices, which increases their cost, size and power consumption. Furthermore, a significant number of fixed stations is required for a given service area as compared to an equivalent system that is RF based since the propagation distance of ultrasound signals is shorter than that of RF signals.

Alternative prior art systems use an indication of the received signal strength such as, for example, RSSI as is used within GSM systems, to determine the position of a mobile device. However, to operate properly, these systems require the radio environment to be thoroughly investigated and set up. Furthermore, these systems typically require a lengthy and complex calibration procedure to be undertaken to initialise the system.

It is an object of embodiments of the present invention to at least mitigate some of the problems of the prior art.

### SUMMARY OF INVENTION

Accordingly, a first aspect of embodiments of the present invention provides a positioning system for locating a mobile station; the system comprising a base station, a mobile station and at least three positioning receivers; the positioning receivers comprise collators to collate time information associated with an initial message exchanged between the base station and the mobile station and time information associated with a subsequent message exchanged between the base station and the mobile station in response to the initial message; the positioning system comprising means to calculate, from the collated time information, a plurality of time differences reflecting the differences of times of flight of the subsequent message to selected pairs of the at least three positioning receivers and means to calculate the location of the mobile station from selectable time differences of the plurality of time differences.

Advantageously, embodiments of the present invention allow the position of a mobile device to be calculated without needing to use a specific GPS system providing the mobile device is operable within, for example, a wireless environment such as, for example, a wireless LAN environment. Therefore, for example, a mobile laptop equipped with an 802.11 wireless LAN card can be located using embodiments of the present invention.

Furthermore, it will be appreciated that data packets exchanged between, for example, an access point and a mobile computer via a wireless LAN do not need to contain data relating to the positioning information. Conventional data packets can be used by embodiments of the present invention in locating the position of a mobile computer.

Preferably, embodiments provide a positioning system in which pairs of the plurality of receivers are orthogonally or perpendicularly disposed relative to one another. In alternative embodiments, the receivers are equidistantly disposed relative to one another. Embodiments are provided in which the plurality of receivers comprises three receivers arranged at the vertexes of a triangle such as, for example, an equilateral triangle.

Each one of the plurality of receivers comprises a timer capable of measuring time at a predetermined time resolution. Preferably, the predetermined time resolution is 1 ns or less. Therefore, the duration between an initially transmitted message and a response to that message can be measured according to the predetermined time resolution. It will be appreciated by those skilled in the art that the resolution with which the duration can be measured influences the accuracy with which the mobile device can be located.

In preferred embodiments, the mobile station, the access point or base station and the plurality of receivers are substantially coplanar.

Embodiments are provided in which the means to calculate the location of the mobile station from the selectable time differences of the plurality of time differences comprises means to determine the intersection between a first nonlinear function associated with a first time difference of the plurality of time differences with a second nonlinear function associated with at least a second time difference of the plurality of time differences. Preferably, the first and second nonlinear functions are hyperbolic functions describing respective hyperbolic curves.

It will be appreciated that embodiments of the present invention can be realised in which the access point, mobile station and the plurality of positioning receivers are not coplanar. Therefore, embodiments provide a positioning system in which the means to calculate the location of the mobile station from selectable time differences of the plurality of time differences comprises means to determine the intersection between a first nonlinear surface associated with the a first time difference of the plurality of time differences and a second nonlinear surface associated with at least a second time difference of the plurality of time differences. Preferably, the first and second nonlinear surfaces are hyperbolic surfaces. Still further embodiments are provided in which the intersection of at least four nonlinear surfaces is determined to locate the mobile station. In any such embodiments, the at least four nonlinear surfaces can be at least four hyperbolic surfaces associated with at least four sets of time differences.

Preferred embodiments provide a positioning system in which the means to calculate the plurality of time differences comprises means to calculate
(tm2−tm1)=Δt PR2+ta2−ΔtPR1−ta1
(tm3−tm2)=Δt PR3+ta3−ΔtPR2−ta2
(tm3−tm1)=Δt PR3+ta3−ΔtPR1−ta1
where

(tm2−tm1), (tm3−tm2), and (tm3−tm1) are the plurality of time differences representing the differences in times of flight of a message from the mobile station to a first, second and third pairs of the plurality of pairs of positioning receivers;

Δt PR1, Δt PR2 and Δt PR3 are time differences between detection of points in time associated with the initial message and points in time associated with a subsequent message; ta1, ta2, and ta3 are the times of flight of a message, transmitted by the base station, to reach first, second and third positioning receivers respectively of the plurality of positioning receivers;

tm1, tm2, and tm3 are the times of flight of a message, transmitted by the mobile station, to reach the first, second and third positioning receivers respectively of the plurality of positioning receivers.

Embodiments, preferably, provide a positioning system in which the collators are arranged to output collated time information for use in determining the position of the mobile station periodically. Preferably, the time period is every 500 ms.

Preferably, embodiments provide a positioning system further comprising means to calculate the relative positions of the mobile station and the base station. In preferred embodiments, the relative positions of the mobile station and the base station are used to influence transmit powers of at least one of the mobile station and the base station. Advantageously, controlling power consumption according to separation distances might allow an overall reduction in power consumption to be realised.

Embodiments provide a positioning system in which the means to calculate the location of the mobile station from selectable time differences of the plurality of time differences comprises means to periodically calculate the location of the mobile station from selectable time differences of the plurality of time differences. Preferably, the time period for calculating the position is every 500 ms.

A second aspect of embodiments of the present invention provides a method for determining the position of a mobile station, the method comprising the steps of determining differences in times of flight of a data packet exchanged between a mobile station and a base station to least first and second pairs of receivers; and determining the location of the mobile station from the differences in the times of flight.

It will be appreciated that embodiments of the present invention can be realised using software. The software can be stored using appropriate storage such as, for example, a device like a chip or PROM, or a medium like a magnetic or optical disc. Suitably, a third aspect of embodiments of the present invention provides a computer program product comprising computer readable storage storing computer executable code means to implement a system or method as described or claimed herein.

### BRIEF DESCRIPTION OF THE DRAWINGS

Embodiments of the present invention will now be described, by way of example only, with reference to the accompanying drawings in which:

FIG. 1 shows a positioning system according to an embodiment;

FIG. 2 depicts a plurality of positioning curves representing possible positions of a corresponding mobile station;

FIG. 3 shows the intersection of two positioning curves; and

FIG. 4 illustrates, schematically, a positioning receiver according to an embodiment.

### DETAILED DESCRIPTION OF THE PREFERRED EMBODIMENTS

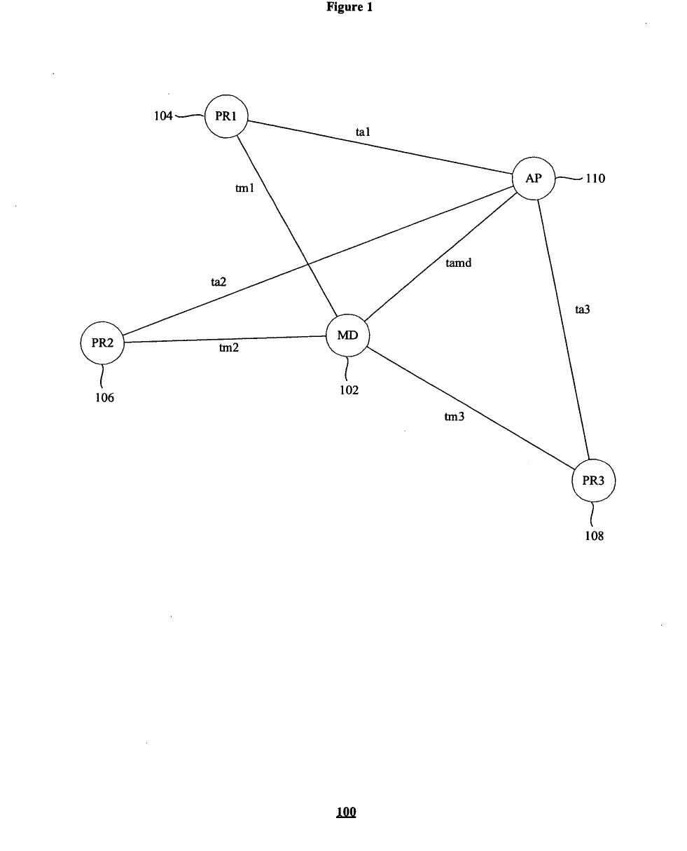

Referring to FIG. 1, there is shown a positioning system 100 for determining the position of a mobile device (MD) 102. The mobile device 102 can be, for example, a laptop computer or any other mobile computer, computing device or any other device such as, for example, a mobile communication device. It will be appreciated that those mobile devices are realisation of mobile stations. The positioning system comprises a plurality of positioning receivers (PR1, PR2, PR3) 104, 106 and 108. It can be appreciated that the embodiment shown uses three positioning receivers. However, embodiments of the present invention can be realised using three or more positioning receivers.

The mobile device 102 is operable to communicate with an access point 110 using a wireless communication protocol. It will be appreciated that an access point is an embodiment of a base station. Access points can also bridge to each other. There are various types of access points and base stations used in both wireless and wired networks. These include bridges, hubs, switches, routers and gateways. The differences between them are not always precise, because certain capabilities associated with one can also be added to another. For example, a router can perform bridging, and a hub may also be a switch. However, they are all involved in making sure data is transferred from one location to another. A bridge connects devices that all use the same kind of protocol. A router can connect networks that use different protocols. It also reads the addresses included in the packets and routes them to the appropriate computer station, working with any other routers in the network to choose the best path to send the packets on. A wireless hub or access point adds capabilities such as roaming and provides a network connection to a variety of clients, but it does not allocate bandwidth. A switch is a hub that has extra intelligence. It can read the address of a packet and send it to the appropriate computer station. A wireless gateway is an access point that provides additional capabilities such as NAT routing, DHCP, firewalls, security, etc. It will be appreciated by those skilled in the art that an access point is a wireless LAN transceiver or “base station” that can connect a wired LAN to one or many wireless devices.

Preferably, the access point 110 provides or supports a wireless LAN environment using, for example, a wireless LAN protocol such as, for example, one of the 802.11 protocol families. Embodiments can be realised that use 802.11b or 802.11g protocols. As is conventional, the mobile station and the access point communicate by exchanging data packets. The transmissions carrying the data packets are omnidirectional. Therefore, any data packets transmitted by the mobile station or the access point can also be received by any or all of the positioning receivers.

The positioning receivers can communicate with one another via an appropriate means such as, for example, a wired or wireless LAN (not shown) or by any other means. The positioning receivers 104 to 108 are arranged to record the points in time at which a data packet, transmitted by the access point 110, is received at those positioning receivers 104 to 108. The positioning receivers 104 to 108 are also arranged to record the points in time at which a data packet, transmitted by the mobile device, is received at those positioning receivers 104 to 108. In preferred embodiments, the data packet transmitted by the mobile device 102 is transmitted in response to receiving the most recently received data packet transmitted by the access point 110. Preferably, the times at which the data packets are received by the positioning receivers are recorded using a predetermined resolution. In preferred embodiments, the predetermined resolution is 1 ns or less.

In preferred embodiments, the positioning receivers 104 to 108 record the IP addresses of at least one of the originating and destination devices to allow any time information associated with those devices to be correlated when determining the position of the mobile station 102.

In preferred embodiments, the positioning receivers 104 to 108 are arranged such that a selected one of those receivers is designated as the master positioning receiver such as, for example, the first positioning receiver 104. The remaining positioning receivers, that is, the second 106 and third 108 positioning receivers, are arranged to transmit their respective collated time information to the master positioning receiver. In preferred embodiments, the collated time information is transmitted to the master positioning receiver every 500 ms.

The master positioning receiver comprises means to calculate a plurality of time differences according to the following:
(tm2−tm1)=Δt PR2+ta2−ΔtPR1−ta1
(tm3−tm2)=Δt PR3+ta3−ΔtPR2−ta2
(tm3−tm1)=Δt PR3+ta3−ΔtPR1−ta1
where

(tm2−tm1), (tm3−tm2),and (tm3−tm1) represent the differences in times of flight of a message from the mobile station to selected pairs of positioning receivers;

Δt PR1, Δt PR2 and Δt PR3 are time differences between detection of points in time associated with the initial message and points in time associated with a subsequent message;

ta1, ta2, and ta3 are the times of flight for a message transmitted by the base station to reach the first 104, second 106 and third 108 positioning receivers respectively;

tm1, tm2, and tm3 are the times of flight for a message transmitted by the mobile station to reach the first 104, second 106 and third 108 positioning receivers respectively.

In preferred embodiments, the master positioning system, or any of the other positioning systems or any other system charged with calculating the position of the mobile device, is arranged to calculate the position of the mobile periodically. In preferred embodiments, the time period for that calculation is every 500 ms.

It will be appreciated that the above is based on the following theory.

The time taken for a message transmitted by the access point 110 to reach the first positioning receiver 104 is ta1. The total time taken, measured from the transmission of the initial message by the access point 110, for a message transmitted by the mobile station 102 transmitted in response to the initial message, to reach the same positioning receiver is the time taken for the initial message to reach the mobile station 102 from the access point 110, plus the time taken for the mobile station 102 to process that message and to generate a response thereto plus the time taken for that response to reach the positioning receiver 102. Therefore, the difference in time between receipt of an initial and a subsequent message at each of the positioning receivers 104 to 108 can be expressed mathematically as follows
Δt PR1=(tamd+tp+tm1)−ta1
Δt PR2=(tamd+tp+tm2)−ta2
Δt PR3=(tamd+tp+tm3)−ta3

tamd is the time taken for a message transmitted by the access point 110 to reach the mobile station 102,

tp is the processing time taken by the mobile station to process a received message and to transmit a reply thereto;

tm1, tm2, and tm3 are the times taken for the message output by the mobile station 102 to reach the positioning receivers; and

ta1, ta2, and ta3 are the times taken for the message output by the access point 110 to reach the positioning receivers.

The above equations can be transposed to give
Δt PR1−tm1+ta1=tamd+tp
Δt PR2−tm2+ta2=tamd+tp
Δt PR3−tm3+ta3=tamd+tp

Therefore,
ΔtPR1−tm1+ta1=ΔtPR2−tm2+ta2=Δt PR3−tm3+ta3.

This can be used to obtain the following three expressions:
Δt PR1−tm1+ta1=Δt PR2−tm2+ta2
Δt PR2−tm2+ta2=Δt PR3−tm3+ta3
Δt PR1−tm1+ta1=Δt PR3−tm3+ta3

Transposing these three expressions gives
tm2−tm1=Δt PR2+ta2−Δt PR1−ta1
tm3−tm2=Δt PR3+ta3−Δt PR2−ta2
tm3−tm1=Δt PR3+ta3−Δt PR1−ta1

Now, the time differences Δt PR1, Δt PR2 and Δt PR are measured at the positioning receivers 104 to 108, the times of flight, ta1, ta2, and ta3, from the access point 110 to the positioning receivers can be calculated since the mutual positions are fixed and known in advance. Therefore, it can be appreciated that the time differences, (tm2−tm1), (tm3−tm2), and (tm3−tm1), can be calculated.

Each of these time differences, (tm2−tm1), (tm3−tm2), and (tm3−tm1), allows a locus of possible positions for the mobile station 102 to be calculated. It will be appreciated that maintaining a constant difference from foci to a point describes a non-linear function and, more specifically, describes hyperbola. It can be appreciated that two positioning receivers of any selected pair of positioning receivers represent the foci of the hyperbola and that the time difference corresponding to that pair of selected positioning receivers represents the constant distance to the mobile station 102 to be maintained in describing the hyperbola.

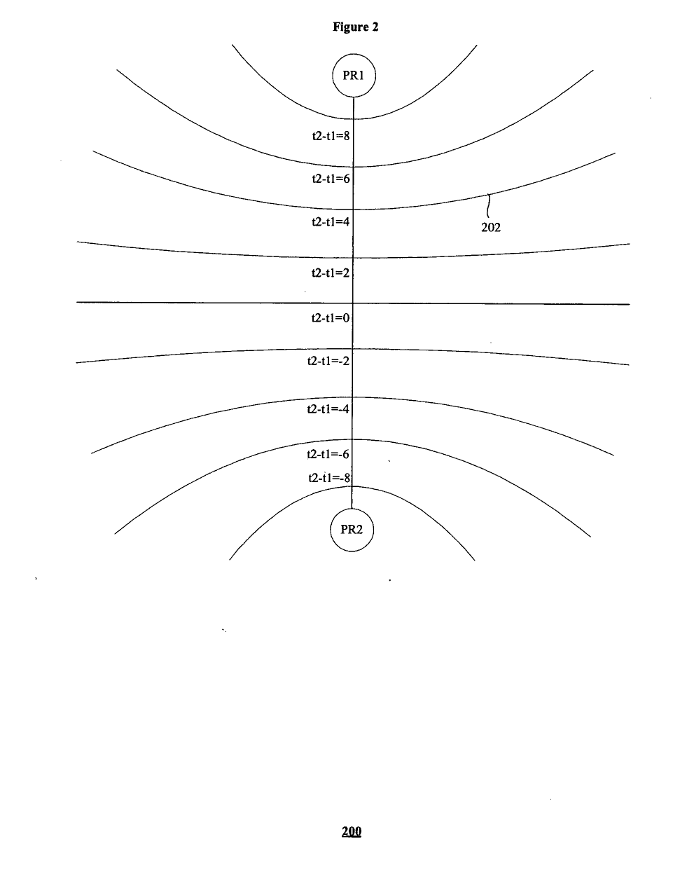

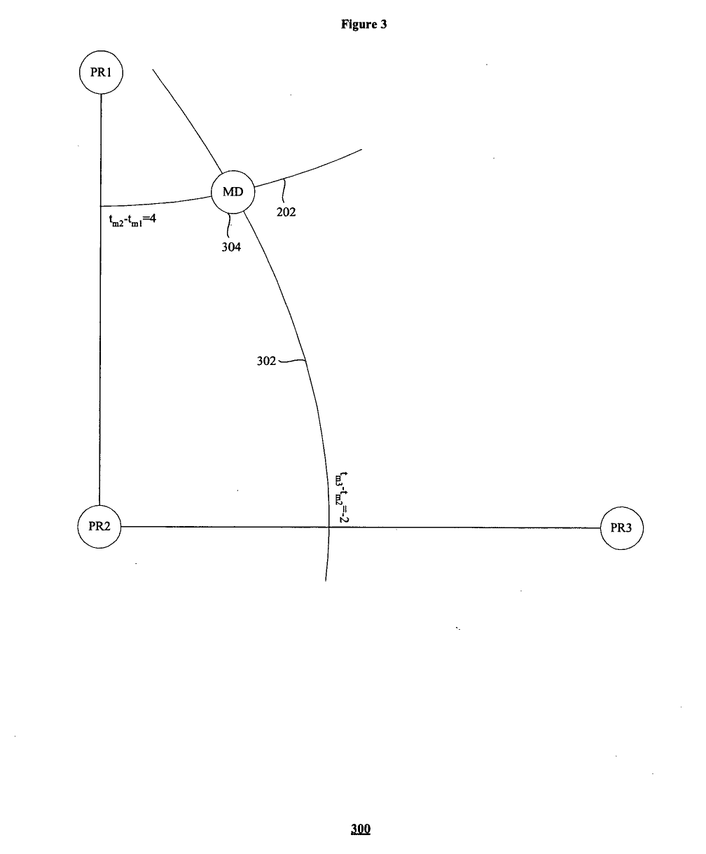

Referring to FIG. 2 there is shown a graph 200 showing a number of loci representing possible paths along which a notional mobile station can be located for given time differences associated with the first and second position receivers. For example, the third locus 202, measured from the first positioning receiver 104, represents a possible path on which the mobile station 102 can be located if the time difference (tm2−tm1) is equal to four. It will be appreciated that the time difference can be measured in terms of arbitrary units. Therefore, for a given time difference, (tm2−tm1)=4, the location of the mobile station 102 on the hyperbola 202 needs to be determined. FIG. 3 shows a graph 300 comprising the hyperbola 202, representing the locus of possible positions for the mobile station 102 given the time difference (tm2−tm1)=4, and a further hyperbola 302 representing a locus of possible mobile station positions given a corresponding time difference, (tm3−tm2)=2, in relation to the second and third positioning receivers. It will be appreciated that the position of the mobile station 102 can be determined from the point of intersection 304 of the hyperbolas 202 and 302.

In preferred embodiments, at least three positioning receivers are used in addition to the access point 110. Preferably, the positioning receivers are properly disposed within a wireless LAN environment. A preferred arrangement for the positioning receivers is that they should not be aligned, that is, they should not be colinear and they should be, preferably, as close to being orthogonal or mutually perpendicular as possible within a given plane. An acceptable relationship for the three positioning receivers is to have them disposed at the vertices of a triangle. In preferred embodiments the triangle is an equilateral triangle.

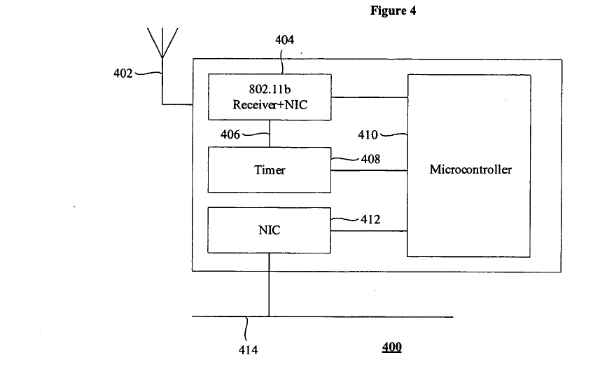

FIG. 4 shows a schematic representation of a positioning receiver 400. The positioning receiver comprises an antenna 402 coupled to an 802.11b receiver 404 for detecting the data packets transmitted by the access point 110 and the mobile station 102. The receiver 404 is arranged to generate an event 406 for controlling a timer 408 to record the point in time at which data packets have been received from either of the access point 110 or the mobile station 102. The receiver 404 and the timer 408 are connected to a microcontroller 410 arranged to extract any network addresses received by the receiver 404, to match any such network addresses with corresponding times and to store those network addresses and times for subsequent transmission to the master positioning receiver. It will be appreciated that the microcontroller will execute corresponding software to realise its functions. Suitably, the microcontroller in conjunction with its software represents at least part of a realisation of a collator.

In a preferred embodiment, the timer is realised using a fast 32-bit incrementing circuit, which continuously counts the output of a 1 GHz oscillator. Upon receiving an indication from the receiver 404 that a message has been received, the current value of the counter is stored in the 32-bit register, which can be read by the microcontroller 410. Therefore, the time duration between successively received data packets can be calculated from the values stored in the 32-bit register.

It can be appreciated that the positioning receiver 400 also comprises a conventional network interface 412 to support communication with, for example, a wired LAN 414. The LAN 414 enables the positioning receivers to output their network address and timing information.

The microcontroller coordinates the actions of the positioning receiver. Its main tasks are to detect the receipt of successive data packets and to calculate the time period between the receipt of those successive data packets, to send any recorded data, in the form of network addresses and corresponding time differences, to the master positioning receiver and, if the positioning receiver is a master positioning receiver, to calculate the position of any mobile device within the wireless environment serviced by the access points and the positioning receivers. The master positioning receiver is also arranged to output the position information to at least one of the access point, mobile station or other data processing system for subsequent use.

It will be appreciated by those skilled in the art that the positioning system will need to be initialised. The initialisation process is used to calculate the times of flight of data packets exchanged between the access point 110 and the positioning receivers 104 to 108. Any such time of flight information can be determined from either actual measurements during calibration or from actual position data, that is, the distances separating the access point 110 and the positioning receivers. The actual positions of the access point and the positioning receivers is determined using a local or relative co-ordinate system. The master positioning receiver, or other device charged with calculating the position of the mobile station, is informed of the positions of the access point and the positioning receivers. The position data, in conjunction with the time differences, can be used to calculate the position, in terms of the local co-ordinate system, of the mobile station.

In an alternative embodiment, in which the positioning receivers can communicate wirelessly with the access point, the actual times of flight are measured using a ping protocol between the positioning receivers and access point, that is, a positioning receiver outputs a message to the access point to which a reply is expected. The access point 110, in response to receiving the initial message, outputs the reply. Assuming it is known how long the processing takes within the access point 110 to produce a reply, the time, T, taken for the round trip will be given by t_{PR1-AP}+t_{APP}+t_{AP-PR1}, where t_{PR1-AP} is the time taken for the initial message to reach the access point from the positioning receiver, t_{APP} is the internal access point processing time, which is known or measurable, and t_{AP-PR1} is the time of flight of a response message output from the access point 110 to the positioning receiver in response to the initial message. Since t_{PR1-AP}=t_{AP-PR1}, the time of flight between the positioning receiver and the access point can be calculated from (T−t_{APP})/2. This time can be determined for all of the positioning receivers used in an embodiment. Furthermore, the pinging can take place between the access point and the receivers, in which case the internal processing time will be that of positioning receivers, t_{PRP}, rather than that of the access point.

Even though the above embodiments have been described with reference to the access point, the mobile station and the three positioning receivers being coplanar, embodiments are not limited to such an arrangement. Embodiments can be realised in which the access point, the mobile station and positioning receivers are not coplanar. However, it will be appreciated that instead of finding the intersection between two hyperbolic curves, one skilled in the art would seek to find the intersection between two or more, and preferably, at least four, hyperbolic surfaces. Therefore, it will be appreciated that such systems might use four or more positioning receivers.

Even though the above embodiments have been described with reference to the message transmitted by the mobile station being in response to receiving the most recently received message from the access point 110. It will be appreciated that any two messages exchanged between the access point 110 and the mobile station 102 can be used providing the mobile station processing time, tp, is known.

It will be appreciated that once the relative positions of the mobile station and the access point are known, the transmit powers of at least one of the mobile station and the access point can be adjusted according to the relative positions. Advantageously, the power consumption of the access point or of the mobile station can be managed so as, for example, to maintain a predeterminable bit error rate performance or merely to save power by reducing transmit powers.

Although the above embodiments have been described with reference to the access point 110 transmitting an initial message, embodiments are not limited to such an arrangement. Embodiments can be realised in which the mobile station transmits an initial message. It will be appreciated that the signs of the time differences in such embodiments will be reversed, that is, instead of determining (tm2−tm1), (tm3−tm2), and (tm3−tm1), the following time differences will be determined (tm1−tm2), (tm2−tm3), and (tm1−tm3).

The above embodiments have been described with reference to one of the plurality of positioning receivers performing the calculations for determining the position of the mobile station. Embodiments can be realised in which the calculations for determining the position of the mobile station can be performed by, for example, the base station, that is, access point or some other network element. Still further, embodiments can be realised in which the mobile station performs the calculations. However, an advantage of positioning receivers performing the calculations is that the traffic associated with collating the time information will not adversely affect the performance of the wireless LAN as it might if it was sent to the mobile device.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings) and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A positioning system for locating a mobile station; the system comprising a base station, a mobile station and at least three positioning receivers; the positioning receivers comprise collators to collate time information associated with an initial message exchanged between the base station and the mobile station and time information associated with a subsequent message exchanged between the base station and the mobile station in response to the initial message; the positioning system comprising means to calculate, from the collated time information, a plurality of time differences reflecting the differences of times of flight of the subsequent message to selected pairs of the at least three positioning receivers and means to calculate the location of the mobile station from selectable time differences of the plurality of time differences.

2. A positioning system as claimed in claim 1 in which pairs of the plurality of positioning receivers are orthogonally or perpendicularly disposed relative to one another.

3. A positioning system as claimed in claim 2 in which the receivers are equidistantly disposed relative to one another.

4. A positioning system as claimed in claim 1 in which the plurality of positioning receivers are arranged at the vertices of a triangle.

5. A positioning system as claimed in claim 4 in which the triangle is an equilateral triangle.

6. A positioning system as claimed in claim 1 in which each of the plurality of positioning receivers comprises a timer capable of measuring time at a predetermined time resolution.

7. A positioning system as claimed in claim 6 in which the predetermined time resolution is 1 ns or less.

8. A positioning system as claimed in claim 1 in which the mobile station, the base station and the plurality of receivers are substantially coplanar.

9. A positioning system as claimed in claim 1 in which the means to calculate the location of the mobile station from selectable time differences of the plurality of time differences comprises means to determine the intersection between a first nonlinear function associated with a first time difference of the plurality of time differences with a second nonlinear function associated with at least a second time difference of the plurality of time differences.

10. A positioning system as claimed in claim 9 in which the first and second nonlinear functions are hyperbolic functions describing respective hyperbolic curves.

11. A positioning system as claimed in claim 1 in which the base station, mobile station and the plurality of positioning receivers are not coplanar.

12. A positioning system as claimed in claim 11 in which the means to calculate the location of the mobile station from selectable time differences of the plurality of time differences comprises means to determine the intersection between a first nonlinear surface associated with a first time difference the plurality of time differences and a second nonlinear surface associated with at least a second time difference of the plurality of time differences.

13. A positioning system as claimed in claim 12 in which the first and second nonlinear surfaces are hyperbolic surfaces.

14. A positioning system as claimed in claim 1 in which the means to calculate the plurality of time differences comprises means to calculate
(tm2−tm1)=ΔtPR2+ta2−ΔtPR1−ta1
(tm3−tm2)=ΔtPR3+ta3−ΔtPR2−ta2
(tm3−tm1)=ΔtPR3+ta3−ΔtPR1−ta1
where
(tm2−tm1), (tm3−tm2), and (tm3−tm1) are the plurality of time differences representing the differences in times of flight of the subsequent message from the mobile station to first, second and third pairs of the plurality of pair of positioning receivers;
Δt PR1, Δt PR2 and Δt PR3 are time differences between detection of a point in time associated with the initial message and a point in time associated with the subsequent message;
ta1, ta2, and ta3 are the times of flight for the initial message transmitted by the base station to reach first, second and third positioning receivers respectively of the plurality of positioning receivers;
tm1, tm2, and tm3 are the times of flight for the subsequent message transmitted by the mobile station to reach the first, second and third positioning receivers respectively of the plurality of positioning receivers.

15. A positioning system in which the collators are arranged to periodically output collated time information for use in position determining.

16. A positioning system as claimed in claim 15 in which the time period is every 500 ms.

17. A positioning system as claimed in claim 1 further comprising means to calculate the relative positions of the mobile station and the base station.

18. A positioning system as claimed in claim 17 further comprising means to influence transmit powers of at least one of the mobile station and the base station according to the relative positions of the mobile station and the base station.

19. A positioning system as claimed in claim 1 in which the means to calculate the location of the mobile station from selectable time differences of the plurality of time differences comprises means to periodically calculate the location of the mobile station from selectable time differences of the plurality of time differences.

20. A positioning system as claimed in claim 19 in which the means to periodically calculate the location of the mobile station from selectable time differences of the plurality of time differences comprises means to calculate the location of the mobile station from selectable time differences of the plurality of time differences every 500 ms.

21. A positioning receiver for a positioning system as claimed in claim 1.

22. A master positioning receiver for a positioning system as claimed in claim 1.

23. A data processing system comprising system to calculate, using differences in times of flight of data packets to reach selected pairs of positioning receivers from a mobile station, the position of a mobile station, wherein the time of flight data packets are derived from data packets received at the positioning receivers from at least one of the mobile station and a base station.

24. A method for determining the position of a mobile station, the method comprising the steps of determining differences in times of flight of data packets exchanged between a mobile station and base station to at least first and second pairs of receivers; and determining the location of the mobile station from the differences in the times of flight.

25. A computer program product comprising computer readable storage storing computer executable code means to implement a system or method as claimed in claim 1.
